(19) United States
(12) Patent Application Publication
(10) Pub. No.: US 2004/0046375 A1
(43) Pub. Date: Mar. 11, 2004

(54) Tubular airbag for installation in a vehicle

(76) Inventors: Paul Lincoln, Nierstein (DE); Andreas Staub, Sulzbach am Main (DE); Hans Lochmann, Niedernhausen (DE); Michael Bieg, Russelsheim (DE)

Correspondence Address: Lonnie R. Drayer, Breed Technologies, Inc., P.O. Box 33050, Lakeland, FL, 33807-3050, US

(21) Appl. No.: 10/449,904

(22) Filed: Jun. 2, 2003

(30) Foreign Application Priority Data
Sep. 11, 2002 (DE) 102 42 023.8

(51) Int. Cl. B60R 21/16

(52) U.S. Cl. 280/743.1

(57) ABSTRACT

An airbag for an airbag module is a section of a seamless continuous tube, at least partly gastight with the free ends of the tube closed and in its inflated state essentially maintains its original volume and its original length. An airbag module includes the airbag and an airbag inflator, which is or can be connected with the airbag. The tubular airbag may be installed in either a seat cushion or seat back of a vehicle seat to act as a barrier to a seat occupant sliding out of the seat when the airbag is deployed.

### FIELD OF THE INVENTION

The present invention relates to an airbag, an airbag module, a vehicle seat comprising an airbag and the use of a seamless continuous tube as an airbag for an airbag module.

### DISCUSSION OF THE PRIOR ART

Airbags in the shape of a tube are known from the prior art. EP 0 936 109 B1, for instance, describes a tube-shaped airbag, which is installed in the region of the A and B pillars and the roof track of a vehicle and thus spans the side window opening. During the deployment of the airbag, the tube inflates and increases in diameter, while its length decreases significantly. This is necessary for the tube to pull itself out of its accommodation and to create an essentially straight line between its two anchor points. Only in this manner does the tube structure create a taut, semi-rigid component, which is tensed transversely spanning the window opening. These types of tube-shaped airbags or shrouds are manufactured using a weaving machine, whereby the warp and weft threads run at an angle of approximately 45° to the axial direction of the tube.

Due to the flexible structure of this type of tube it is not possible, however, precisely to control or predict its expansion, i.e. its geometric shape change. This type of tube also comprises a high number of individual components, e.g. several tube layers, fastening means, closing means etc. resulting in very high manufacturing costs.

### SUMMARY OF THE INVENTION

There is provided in accordance with one aspect of the invention an airbag comprising a seamless continuous tube formed from a flexible and/or woven material, so that the airbag displays an unstable cross section in its deflated state, at least partly gastight with closing means for closing the free ends of the tube, the airbag when inflated essentially maintains an original volume and an original length.

There is provided in accordance with another aspect of the invention an airbag module comprising an airbag comprising a seamless continuous tube formed from a flexible and/or woven material, so that the airbag displays an unstable cross section in its deflated state, at least partly gastight with closing means for closing the free ends of the tube, the airbag when inflated essentially maintains an original volume and an original length and an airbag inflator arranged to provide inflation gas to the interior of the airbag.

There is provided in accordance with another aspect of the invention a vehicle seat comprising a seat back and a seat cushion, wherein an airbag comprising a seamless continuous tube formed from a flexible and/or woven material, so that the airbag displays an unstable cross section in its deflated state, at least partly gastight with closing means for closing the free ends of the tube, the airbag when inflated essentially maintains an original volume and an original length is arranged in a side region of the seat back.

There is provided in accordance with another aspect of the invention a vehicle seat comprising a seat back and a seat cushion, wherein an airbag comprising a seamless continuous tube formed from a flexible and/or woven material, so that the airbag displays an unstable cross section in its deflated state, at least partly gastight with closing means for closing the free ends of the tube, the airbag when inflated essentially maintains an original volume and an original length is arranged in a front region of the seat cushion.

There is provided in accordance with another aspect of the invention a vehicle having a passenger compartment wherein an airbag comprising a seamless continuous tube formed from a flexible and/or woven material, so that the airbag displays an unstable cross section in its deflated state, at least partly gastight with closing means for closing the free ends of the tube, the airbag when inflated essentially maintains an original volume and an original length is arranged to protect a leg of a vehicle occupant when the airbag is inflated.

There is provided in accordance with another aspect of the invention a vehicle having a passenger compartment wherein an airbag comprising a seamless continuous tube formed from a flexible and/or woven material, so that the airbag displays an unstable cross section in its deflated state, at least partly gastight with closing means for closing the free ends of the tube, the airbag when inflated essentially maintains an original volume and an original length is arranged to elevate a foot of a vehicle occupant when the airbag is inflated.

### BRIEF DESCRIPTION OF THE DRAWINGS

FIG. 1 is an elevation view, partially broken away, of a first embodiment of the airbag module according to the invention.

FIG. 2a is an elevation view, partially broken away, of a second embodiment of the airbag module according to the invention.

FIG. 2b is a cross sectional view of a section of the second embodiment of the airbag module according to the invention.

FIG. 3a is an elevation view, partially broken away, of a third embodiment of the airbag module according to the invention.

FIG. 3b is a cross sectional view of the third embodiment of the airbag module according to the invention taken along line 3b-3b of FIG. 3a.

FIG. 4 is an elevation view, partially broken away, of a fourth embodiment of the airbag module according to the invention.

FIG. 5 is a sectional view of a fifth embodiment of the airbag module according to the invention.

FIG. 6a is an elevation view of a sixth embodiment of the airbag module according to the invention.

FIG. 6b is a cross sectional view of the sixth embodiment of the airbag module according to the invention taken along line 6b-6b of FIG. 6a.

FIG. 7 is a top view of a first embodiment of a vehicle seat according to the invention.

FIG. 8 is a top view of a second embodiment of the vehicle seat according to the invention.

FIG. 9 is a top view of a third embodiment of the vehicle seat according to the invention.

### DETAILED DESCRIPTION OF THE INVENTION

There is provided in accordance with the present invention an airbag for an airbag module, an airbag module, a vehicle seat comprising the airbag module and the use of a continuous tube as an airbag, whereby the airbag can be manufactured in a cost-effective manner according to a safe manufacturing process, and whereby its geometric shape change during and after inflation can be essentially predetermined or preset.

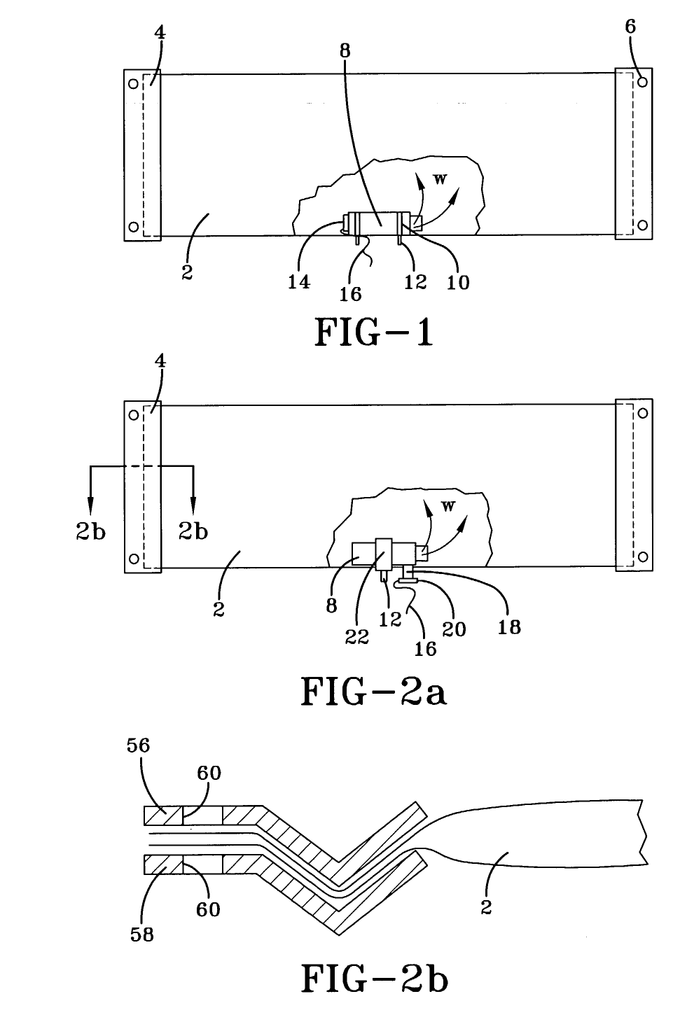

FIG. 1 shows a first embodiment of an airbag module according to the invention. The airbag module comprises an airbag 2, the frontal, open ends of which are at least partly closed by closing means 4. The airbag 2 is essentially a section of a continuous tube, which in its inflated state displays an essentially circular cross section along at least most of its length. The two opposite open ends of the airbag 2 are closed by closing means 4 comprising metal clamps. The tube-shaped walls of the airbag 2 are pushed together at its two open ends, i.e. its frontal ends, so that a type of strip-shaped end section is created, which is preferably folded over once towards the opposite end of the middle. This fold or the open end of the airbag 2 is enclosed by the metal clamps 4 so that a gastight closing of the two ends of the airbag 2 is achieved for closing the free ends of the tube and essentially maintaining its original volume and original length during inflation. In this case, part of a conventional tube fabric sold by the meter cut into sections can be advantageously used as a continuous tube. For instance, part of a commonly used fire service hose could also serve this purpose. Because of the closing means closing the free ends of the tube, it is of benefit that the gas is held in the tube at least partly and for a predetermined length of time, so that the tube maintains its inflated or filled state for a length of time which can be predetermined or preset.

The airbag is preferably made out of a flexible and/or woven material, so that the airbag displays an unstable cross section in its deflated state. Due to this lack of dimensional stability, the airbag collapses in its deflated state, so that the essentially tube-shaped cross section presents during inflation results in an essentially strip-like cross section during the deflated state. The deflated structure can then be gathered or folded on the inside or in the upholstery of a vehicle seat in an advantageously simple and space-saving manner. Consequently and-advantageously, no complicated folding process is required for installation of the airbag, as is the case in conventional airbags. In addition, due to the woven material, a basic flexibility of the airbag is achieved, so that it can advantageously be adapted to a vehicle component structure. This type of tube fabric is generally manufactured by belt web weaving looms or circular weaving looms, by means of which a tube is created, the warp threads of which lie in the axial direction of the tube and the weft threads of which lie transversely thereto. A continuous tube fabric is thus created, which cannot be stretched, yet displays certain flexibility.

The airbag is preferably made out of a single- or multi-layered tube. With a single-layered tube, the gas tightness of which is sufficient for certain uses, a very cost-effective and safe tube can advantageously be manufactured. Multi-layered tubes are used in situations where increased gas tightness is required or in which increased resistance against outside influences, e.g. sharp metal edges or the like, is required. To increase the gas tightness, a second layer can be advantageously a coating, and can be arranged preferably on the inside or the outside. This coating can be a polyurethane or silicon coating, which advantageously displays a very high gas tightness with high resistance.

Furthermore the closing means 4 comprising metal clamps have, at their ends lying opposite the airbag 2, one or several fastening holes 6 therethrough, via which the airbag module can be connected to the vehicle structure by fastening means such as threaded fasteners, screws, bolts, rivets or the like. To this effect several smaller metal clamps, with a predetermined distance between them, can be used for closing the open ends or, preferably, in each case one long metal clamp, extending over the entire length of the tube opening, i.e. the length of which corresponds to essentially half the tube circumference, can be used. The metal clamp or clamps preferably contain a region or part made out of synthetic material. Furthermore the airbag can advantageously be fastened to the vehicle structure by means of holes through the metal clamps, to thus advantageously secure the position of the airbag.

Within the airbag 2 an airbag inflator 8 is arranged on the tube interior. The airbag inflator 8 is surrounded by clamps 10, to which screws or bolts 12, projecting outwardly in a radial manner, are welded. The fastening means 12 are inserted through corresponding predetermined openings in the airbag 2 and thus project out of the airbag 2. Via these fastening means 12, the entire arrangement can thus be fastened to the vehicle structure of a vehicle or, if desired, merely the airbag inflator 8 can be fastened to the airbag itself 2. At one frontal side of the airbag inflator 8, a plug 14 is located, via which an ignition lead 16 is connected to the airbag inflator 8. The ignition lead 16 projects outwardly through an opening in the airbag 2 and can be connected to an airbag controller a vehicle. In the event of activation, the gas emission shown in the direction of arrow W takes place at the side of the airbag inflator 8 opposite the plug 14. Due to the fastening of the airbag inflator in or on the airbag by fastening means, an operationally secure airbag module can be advantageously foreseen, since a change in position of the airbag inflator with relation to the airbag does not take place in the event of a crash and thus safe deployment is ensured. However, if desired the airbag inflator can be arranged outside the airbag with the airbag inflator arranged directly on the airbag or be connected to the latter by means of a supply line.

FIG. 2a shows a second embodiment of the airbag module according to the invention. The design of the airbag 2 and the closing means 4 as well as the arrangement of the closing means 4 on the airbag 2 are identical to the embodiment shown in FIG. 1. The airbag inflator 8 is also arranged inside the airbag 2 on a wall of the airbag 2. An igniter 18 of the airbag inflator 8, however, projects outwardly in a radial manner through an opening in the airbag 2. On the outwardly projecting side of the igniter 18, a plug 20 is arranged, via which an ignition lead 16 is connected to the igniter 18 of the airbag inflator 8. A metal bracket 22 encloses the airbag inflator 8 arranged in the airbag 2 from the outside, so that the airbag 2 as well as the airbag inflator 8 is securely clamped in the metal bracket 22. The metal bracket 22 has essentially the shape of an open ring, on the radially outer side of which threaded fasteners 12 are arranged to fasten the airbag module to a vehicle structure.

FIG. 2b shows the closing means 4 of the second embodiment of the airbag module in a magnified cross sectional view. The closing means 4 in this embodiment comprises a clamp, which has an upper part 56 and an essentially congruent to a lower part 58. The two parts 56, 58 are provided with a borehole 60 in alignment to one another for fastening screws or rivets. Preferably, the upper part 56 and/or the lower part 58 or individual regions thereof is/are made out of synthetic material.

In alternative embodiments the ends of the tube are closed by means of gluing, welding, sewing or riveting. To achieve an operationally secure airbag, the ends of the airbag or continuous tube can in this case also advantageously be folded down, and this folded down end can be closed by a glue, or by means of welding, sewing or riveting.

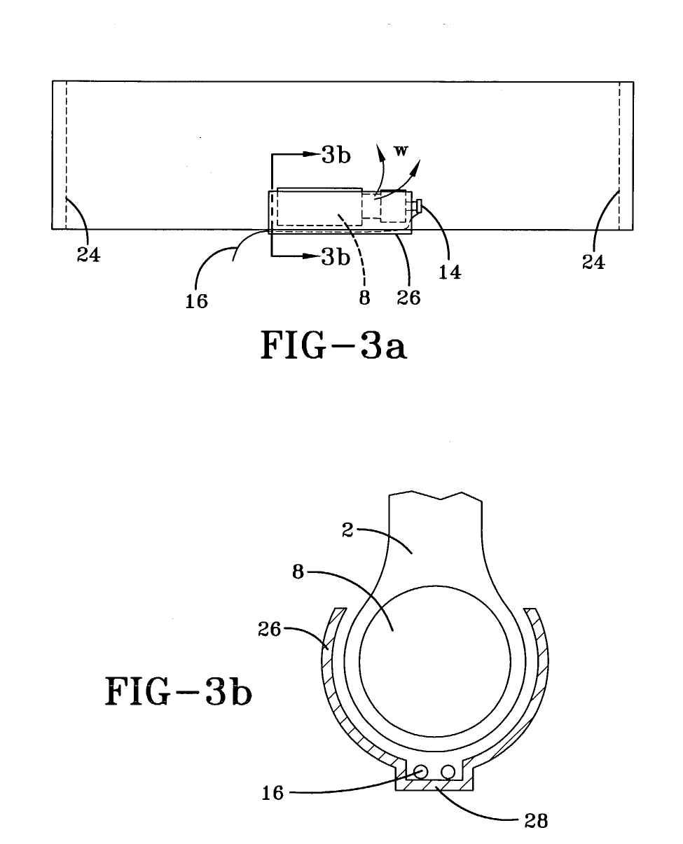

FIGS. 3a and 3b show a third embodiment of the airbag module. In this embodiment, the two open ends of the airbag 2 are closed by sewn seams 24, in that the open ends of the airbag 2 are pushed together, such that in these regions an essentially flat strip is created, the layers of which are stitched together. Prior to being sewn, it is beneficial if the open ends can be folded down once or several times towards the opposite end of the airbag to achieve a higher gas tightness. The arrangement of the airbag inflator 8 essentially corresponds to the arrangement shown in the first embodiment. The airbag inflator 8, however, is merely placed inside the airbag 2 and enclosed from the outside by an essentially tube-shaped-metal bracket 26. As can be seen in FIG. 3b, in its cross section the metal bracket 26 has an essentially open ring structure, which at its inner side, opposite the open side of the ring, comprises a cable channel 28 in the form of an outwardly projecting recess. In this cable channel 28, the ignition lead 16 is outwardly guided via an opening in the airbag 2. As in the second embodiment of the present invention, the metal bracket 26 encloses the airbag 2 as well as the therein arranged airbag inflator 8.

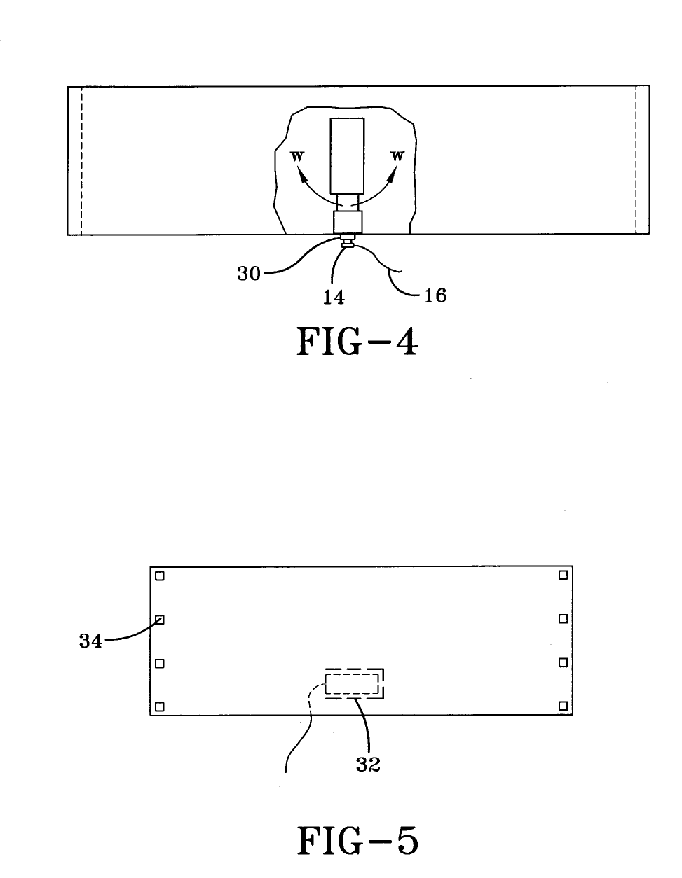

In the fourth embodiment shown in FIG. 4, the airbag inflator 8 is arranged transversely in the airbag 2 and projects outwardly through an opening in the airbag 2 at the end at which the plug 14 is arranged and is connected to an ignition lead 16. The airbag inflator 8 is connected to the airbag 2 in an essentially gastight manner by means of a clamping ring 30 arranged on the part of the airbag inflator 8 projecting out of the airbag 2. In addition, it is beneficial for a connection with the vehicle structure to be established by means of the clamping ring 30, in order to achieve a fastening of the airbag module to the vehicle structure.

In the fifth embodiment of the present invention shown in FIG. 5, the airbag inflator 8 is connected to the airbag 2 merely by means of a weld seam 32. It must be observed in this case that on the basis of the low stability of the weld seam, the airbag inflator 8 should be unaffected by thrusts, i.e. it should emit the gas in two opposite directions, in order to keep the force acting upon the weld seam 32 to a minimum. The open ends of the airbag 2 are closed in an essentially gastight manner by means of rivets 34 or other suitable measures.

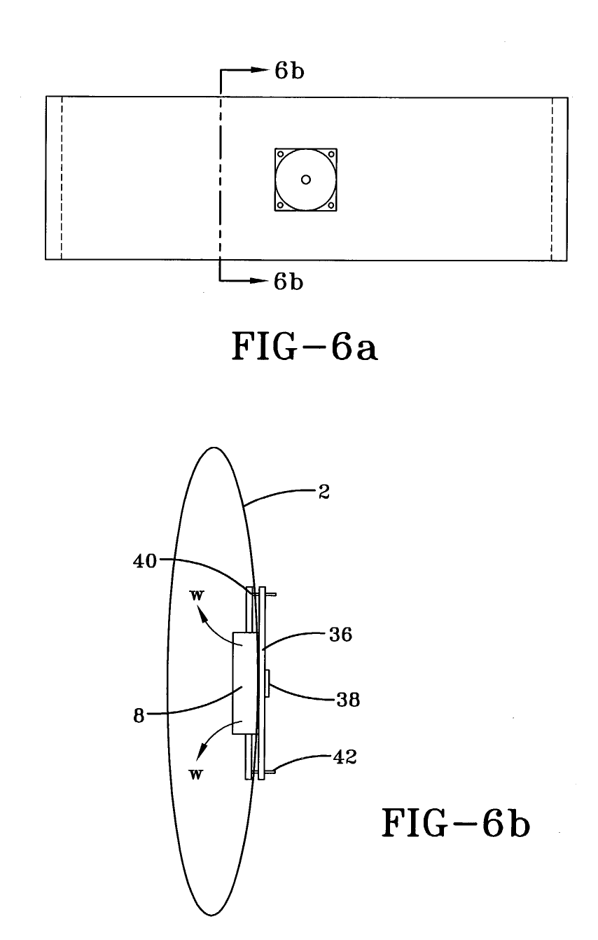

The sixth embodiment shown in FIGS. 6a and 6b of the airbag module according to the invention is similar to a connection variation of the airbag inflator 8 to the airbag 2, as is known from conventional steering wheel airbags. In this case the fastening means comprises an airbag inflator base plate 36, to which the airbag inflator 8 is concentrically fastened. An ignition lead connection 38 is arranged on the airbag inflator 8, which ignition lead connection can be connected directly to the airbag controller of a vehicle, in order to thus activate the airbag inflator 8. In addition, the fastening means comprises a support plate 40, which is preferably a ring-shaped plate. Concentrically in this ring-shaped support plate 40 is an opening, the diameter of which essentially corresponds to the outer diameter of the airbag inflator 8. Furthermore, several threaded fasteners such as threaded bolts 42 are arranged on the support plate 40 in the region of the perimeter of he support plate. The support plate 40 is pushed to the outside from the tube inside of the airbag 2 with the threaded bolts 42 projecting through holes provided in the airbag 2. Furthermore, an opening, which is arranged in the support plate 40 above the opening corresponding to the airbag inflator 8, is arranged in the airbag 2 and corresponds to the outer diameter of the airbag inflator 8. The airbag inflator 8 is placed with the airbag inflator base plate 36 and screwed from the outside upon the outwardly projecting threaded bolts 42. In this way the airbag 2 is clamped between the support plate 40 and the airbag inflator base plate 36 and the opening in the airbag 2 is thus closed in an essentially gastight manner. The airbag module can be securely connected to the vehicle structure via the threaded bolts 42.

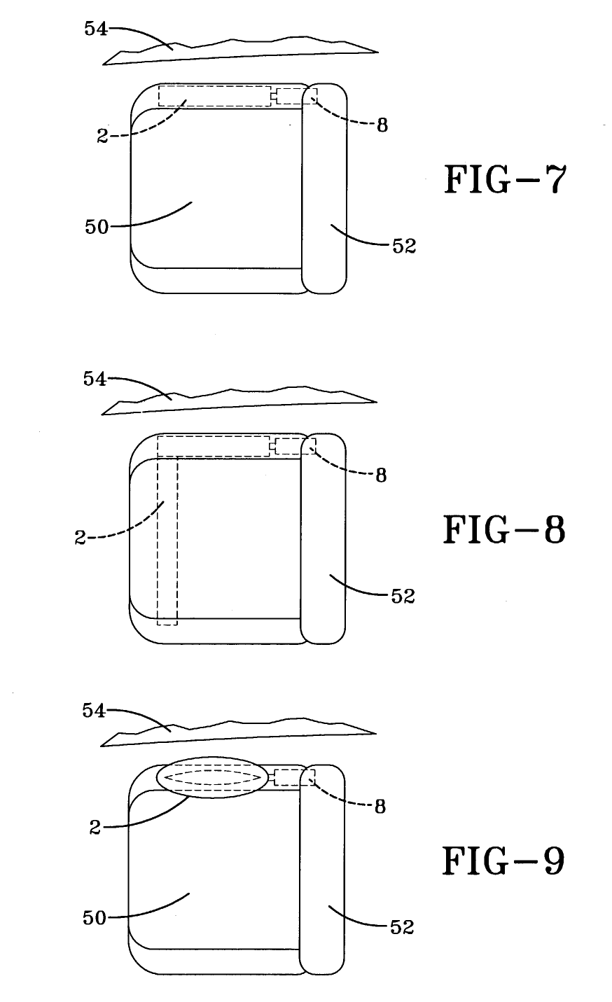

FIG. 7 shows a first embodiment of an arrangement of an airbag module according to the invention installed in a vehicle seat. The vehicle seat comprises a seat cushion 50 and a seat back 52 arranged on one of its sides and standing essentially transverse to a vehicle door 54. The airbag module is arranged in one or both side regions of the seat cushion 50 within the seat and/or as desired in a side and/or front region of the seat cushion. In the event of a crash, the airbag 2 is inflated within the seat, to prevent a seat occupant from sliding under the pelvic belt, known generally as the “submarining effect”. Consequently, the level of injuries to the lower extremities as well as to a crushed chest and the overall body impact to a front airbag can be improved. The side arrangement of this airbag advantageously ensures a secure lateral stabilization of the vehicle occupants, whereby it is avoided that the vehicle occupants shift or move into an undesired position with regard to the side airbag in the event of a side collision.

During the activation of the airbag module the airbag 2 inflates and fills one or both side regions of the seat cushion 50, so that an essentially stiff restraining wall is created in the shape of a “bulge” extending along a lateral edge of the seat cushion. Due to the original volume and the original length of the tube remaining constant, the space requirement or space demand can be advantageously predetermined for the inflated airbag, whereby an exact configuration of the vehicle bodies surrounding the airbag can take place. In addition, due to the use of a conventional continuous tube, manufacturing costs of the airbag can be drastically lowered and due to the absence of a seam, an airbag can be created in an advantageously safe manufacturing process, since there is no risk of a seam tearing. The vehicle seat is preferably designed in such a manner that during inflation of the airbag the outer seat cover material remains undamaged. It can thus be advantageously avoided that during deployment of the airbag, components of the inside of the seat are flung into the passenger space and come into contact with the occupants.

In the second embodiment shown in FIG. 8 of a vehicle seat according to the invention, the airbag 2 is arranged in a side and front region of the seat cushion 50. In this way, the side region and front region of the seat cushion 50 stiffens and rises during the deployment of the airbag, so that a “submarining effect” can be avoided, i.e. the forward slipping of a vehicle occupant on the-seat cushion 50 is prevented in that the front region of the seat cushion 50 is raised and/or stiffened.

The seat can also be designed, however, that during inflation of the airbag, the outer seat material tears open at preset and predetermined regions in a controlled manner, to enable at least part of the airbag to exit onto the surface. An airbag of a higher volume can thus be advantageously used, to achieve an improvement position securing of the vehicle occupants. Through the controlled tearing open of the outer seat material, it is advantageously ensured that the function of the airbag is not restricted and that thus the airbag can work optimally. FIG. 9 shows a third embodiment of the vehicle seat according to the invention. The seat cushion 50 or the seat is designed in such a manner that during an activation of the airbag module and inflation of the airbag 2, on the basis of the latter's increase in volume, the outer seat material tears open in a controlled manner at predetermined or preset regions, e.g. tear seams.

It is furthermore preferable that the closing means close the tube only partly, to enable a pressure release of the airbag after its inflation. Due to a release in pressure, easier access to the vehicle occupant involved in the accident is advantageously rendered possible, since an airbag under low pressure displays low consistency or dimensional stability. The airbag can thus advantageously be easily removed from the vehicle region in question. In addition, through a corresponding arrangement of the closing means, the length of time after which the release in pressure takes place, can advantageously be predetermined, so that the protection effect or period, namely the time that the airbag is fully inflated, can be determined according to each specific crash situation, since in the event of a car turning over a considerably longer protection period of the airbag is required than in the event of a car not rolling over.

An airbag according to the invention may be arranged in a side region of the seat back. This prevents a lateral slipping of the upper body of the occupants in a crash. In this way the upper body of the vehicle occupants is advantageously secured in its position with regard to the front airbag, which in the event of a crash leads to significantly reduced injuries of the upper extremities.

According to the invention, the airbag module according to the invention is used so that the airbag is arranged in the vehicle compartment positioned to protect the leg, especially the knee of a seat occupant. The airbag is accommodated in a region at knee height behind the dashboard casing. As a result of a crash, major injuries to the knees are thus advantageously prevented, since in the event of a crash the knees collide with the airbag and contact with the hard dashboard casing is avoided.

Furthermore, according to the invention, the airbag module according to the invention is used so that the airbag is arranged in the foot region under the foot mat or floor casing of a vehicle. During the activation of this type of foot airbag the feet are lifted up and held away from the region of the pedals. In this case the feet are advantageously protected from the, pedals, whereby an improved protection effect is achieved for the entire shinbone and foot region.

While the present invention has been described in conjunction with specific embodiments thereof, many alternatives, modifications, and variations will be apparent to those skilled in the art in view of the foregoing description. Accordingly, the invention is intended to embrace all such alternatives, modifications, and variations that fall within the spirit and scope of any appended claims.

We claim:

1. An airbag comprising a seamless continuous tube formed from a flexible and/or woven material, so that the airbag displays an unstable cross section in its deflated state, at least partly gastight with closing means for closing the free ends of the tube, the airbag when inflated essentially maintains an original volume and an original length.

2. The airbag according to claim 1 wherein the airbag comprises a multi-layered tube.

3. The airbag according to claim 1 wherein the airbag comprises a single layered tube.

4. The airbag according to claim 1 wherein the closing means are metal clamps, which close the open ends of the tube and by which the airbag can be connected to a vehicle structure.

5. The airbag according to claim 1 wherein the closing means comprises a means selected from the group consisting of gluing, welding, sewing and riveting.

6. The airbag according to claim 1 wherein the closing means close the tube only partly, to enable the pressure release of the airbag after its inflation.

7. An airbag module comprising an airbag comprising a seamless continuous tube formed from a flexible and/or woven material, so that the airbag displays an unstable cross section in its deflated state, at least partly gastight with closing means for closing the free ends of the tube, the airbag when inflated essentially maintains an original volume and an original length and an airbag inflator arranged to provide inflation gas to the interior of the airbag.

8. The airbag module according to claim 7 further comprising fastening means for fastening the airbag inflator in or on the airbag.

9. The airbag module according to claim 8, wherein the fastening means comprises a threaded fastener arranged on the airbag inflator to project through a hole in the airbag.

10. The airbag module according to claim 8, wherein the fastening means is a metal bracket that is arranged outside the airbag, and encloses at least partly the airbag and therein arranged airbag inflator from the outside.

11. The airbag module according to claims 7 wherein the airbag inflator partly projects from an opening in the airbag.

12. The airbag module according to claim 11, whereby the fastening means is a clamping ring, which can be arranged on the part of the airbag inflator which partly projects from the airbag, in order to create an at least partly gastight, positive (interlocking) connection between the airbag inflator and the airbag arranged between the airbag inflator and the clamping ring.

13. The airbag module according to claim 7 wherein the airbag inflator is fastened to the airbag by gluing, welding, sewing or riveting.

14. The airbag module according to claim 8, whereby the fastening means comprises a base plate fastened to the airbag inflator and a support plate arranged within the airbag, so that the airbag is clamped between the base plate and the support plate.

15. A vehicle seat comprising a seat back and a seat cushion, wherein an airbag comprising a seamless continuous tube formed from a flexible and/or woven material, so that the airbag displays an unstable cross section in its deflated state, at least partly gastight with closing means for closing the free ends of the tube, the airbag when inflated essentially maintains an original volume and an original length is arranged in a side region of the seat back.

16. A vehicle seat comprising a seat back and a seat cushion, wherein an airbag comprising a seamless continuous tube formed from a flexible and/or woven material, so that the airbag displays an unstable cross section in its deflated state, at least partly gastight with closing means for closing the free ends of the tube, the airbag when inflated essentially maintains an original volume and an original length is arranged in a side region of the seat cushion.

17. A vehicle seat comprising a seat back and a seat cushion, wherein an airbag comprising a seamless continuous tube formed from a flexible and/or woven material, so that the airbag displays an unstable cross section in its deflated state, at least partly gastight with closing means for closing the free ends of the tube, the airbag when inflated essentially maintains an original volume and an original length is arranged in a front region of the seat cushion.

18. A vehicle having a passenger compartment wherein an airbag comprising a seamless continuous tube formed from a flexible and/or woven material, so that the airbag displays an unstable cross section in its deflated state, at least partly gastight with closing means for closing the free ends of the tube, the airbag when inflated essentially maintains an original volume and an original length is arranged to protect a leg of a vehicle occupant when the airbag is inflated.

19. A vehicle having a passenger compartment wherein an airbag comprising a seamless continuous tube formed from a flexible and/or woven material, so that the airbag displays an unstable cross section in its deflated state, at least partly gastight with closing means for closing the free ends of the tube, the airbag when inflated essentially maintains an original volume and an original length is arranged to elevate a foot of a vehicle occupant when the airbag is inflated.
